(19) United States
(12) Patent Application Publication
(10) Pub. No.: US 2020/0340606 A1
(43) Pub. Date: Oct. 29, 2020

(54) APPARATUS AND METHODS FOR STERILE CONNECTIONS OR CONDUITS

(71) Applicant: Neuma LLC, King of Prussia, PA (US)

(72) Inventors: Shaun R. Devitt, Wayne, PA (US); Alexis M. Dechelette, Jenkintown, PA (US); Andrew N. King, King of Prussia, PA (US); Arthur G. Marlin, Willow Grove, PA (US)

(73) Assignee: Neuma LLC, King of Prussia, PA (US)

(21) Appl. No.: 16/858,064

(22) Filed: Apr. 24, 2020

Related U.S. Application Data
(60) Provisional application No. 62/839,492, filed on Apr. 26, 2019.

(51) Int. Cl. F16L 29/00; F16L 53/35; F16L 53/34

(52) U.S. Cl. CPC F16L 29/005; F16L 2201/44; F16L 53/34; F16L 53/35

(57) ABSTRACT

Apparatus and methods for establishing sterile or disinfected/decontaminated connections or conduits between separate fluid path sub-assemblies. Each section of the fluid path to be connected include one or multiple heatable or heating surfaces, and a sterile volume or chamber defined by at least one of the heatable or heating surfaces. Prior to establishing a sterile access or connection between separate sections of a fluid path, the heatable or heating surfaces are sterilized or disinfected/decontaminated by means of heat. Such means may include ohmic resistive heating, inductive heating, and/or self-heating through an exothermic reaction. All surfaces establishing the connection or conduit are therefore sterile or disinfected/decontaminated, and a sterile connection or conduit is established.

This application claims the benefit of U.S. Provisional Pat. Appln. No. 62/839,492, filed on Apr. 26, 2019, the contents of which are incorporated herein by reference.

### FIELD OF THE DISCLOSURE

The present disclosure relates to sterile medical assemblies, fluid pathways or connectors, and/or device assemblies, and more specifically to applications and processes where one or several assemblies or fluid pathways or connectors must be joined to one or several other assemblies or fluid pathways or connectors in a manner that maintains or enables a part or the whole of the assembly or assemblies to achieve or maintain a sterile, disinfected, or decontaminated state.

### BACKGROUND

There are manifold cases where there is a need to perform a connection or complete an assembly in a fashion where sterility or an otherwise disinfected state needs to be created or maintained as part of the function of the assembly. In a first example, an insulin pen cartridge or vial must be connected to a needle in order to have the insulin delivered subcutaneously to the patient: the exposed outer surface of the elastomeric stopper of the cartridge/vial is not typically maintained sterile and must be disinfected or sterilized at the site of needle penetration in order to keep the insulin sterile as it passes through that connection as part of delivery. In a second example, certain methods of dialysis utilize multiple tubing and/or needle sets (provided pre-sterilized as components or sub-assemblies) that must be joined together in a fashion that maintains the aseptic condition of the bodily fluid contacting surfaces. In a third example, certain instances of blood collection require the use of a number of primary and satellite bags (for the collection of various blood components and/or introduction of other fluids back to the patient) where all the surfaces contacting the blood or other fluids must be maintained sterile during and after the blood collection.

There have been many and various solutions that have been previously disclosed and are well known to those skilled in the art. In a first example, such as applies to the insulin pen cartridge/vial case given above, it is typical to wipe the outside exposed surface of the elastomer with isopropyl alcohol (or equivalent disinfecting solution) just prior to making the needle connection. In a second example, such as it applies to dialysis tubing connections, techniques include making the connections in an aseptic environment or else performing terminal sterilization (through dry heat or steam or similar) of the completed assembly utilizing equipment that must be on-site and configurable for the application. In a third example, such as it applies to blood collection, the entire configuration of primary bags, satellite bags, connectors and tubing must be pre-assembled into the final assembly and terminally sterilized in that configuration.

All such previous solutions have at least one or several drawbacks or disadvantages that either do not fully mitigate the risk of breach of sterility (thus permitting some possibility of healthcare acquired infections) or require additional complexity in the nature or manufacture of the assembly or require an additional process to be performed at the time of the connection that might not be convenient or otherwise desirable, practical, or feasible. In a first example, such as it applies to the insulin pen cartridge/vial case given above, the use of isopropyl alcohol or other liquid disinfectant requires a manual process that might require significant dexterity, or require access to an assembly (such as an automatic insulin pen) that might not be feasible. In a second example, such as it applies to dialysis tubing connections, the use of an aseptic environment or specially configured sterilization equipment to ensure the aseptic connection generally inhibit the widespread adoption of dialysis technologies, especially in home-use. This is because an aseptic environment is not available in home-use, nor is it practical to incorporate costly and/or large sterilization equipment in patients' homes. In a third example, such as it applies to blood collection, a pre-sterilized completed assembly of primary bags, satellite bags, connectors and tubing does not permit any adjustments, additions, or subtractions of components if required for the particular operation.

### SUMMARY

A means of providing a sterile or disinfected/decontaminated connection or access is made by a) having the outside surface of one or more of the to be connected assemblies to comprise a heatable or heating conductive foil (foil may be used to mean foil or film), b) heating up said surface to rapidly achieve the desired state of microbial bioburden reduction or sterilization c) complete the assembly by accessing through the heatable or heating conductive foil (such as piercing, puncturing, sliding away through direct contact) those internal components and/or surfaces thereof that form the connection or access. Unless otherwise specifically described, as generally used herein, the term sterile encompasses sterile, disinfected or decontaminated conditions and the sterilization methods described herein may be utilized to achieve sterile, disinfected or decontaminated conditions unless a specific condition is described and utilized in its scientific context.

One embodiment is to have the foil be heated through direct electrical contact and the application of an electric current, otherwise known and described as Joule Heating or Ohmic Heating. The component may be selected from a variety of electrically conductive materials; such as metals like steel, stainless steel, aluminum, copper, nickel, nichrome, etc., or ceramics like silicon carbide, molybdenum disilicate, etc . . . ; or some combination or alloy thereof to permit a sufficiently uniform and rapid temperature increase and temperature maintenance (if and as required) to perform the desired sterilization or bioburden reduction. The heat generating layer of the foil can be attached to a plastic or other non-electrically conductive layer capable of withstanding the high heat and temperature generated during and following the application of the electric current. Alternately, the component may consist directly of a plastic or polymer film or sheet that is filled with metal powders, ceramic powders, graphite, carbon black, or other conductive materials to create a substrate that is electrically and thermally conductive. The plastic or polymer layer may be from any polymers capable of withstanding the high heat generated during use, for example, but not limited to, polyimide, polytetrafluoroethylene or related fluoropolymers, silicone, etc.

In another embodiment, the outside surface element is a metallic foil or other suitably shaped component that is placed within an electromagnetic field and heated through Induction Heating. The field may be supplied by passing an alternating current through an induction coil suitably arranged around the outside surface element. The means of electrically generating and controlling the eddy currents to produce the induction heating are well known to those having skill in the art. The specific geometry of the induction coil for maximal effectiveness and efficiency in producing the induction heating in the outside surface element depends on the geometry of the assembly and geometry of the element itself and its design may be constructed according to generally known practices. A single coil or multiple coils may be used as well as a single coil that translates relative to the metallic foils or the metallic foils can translate within a single coil or multiple coils. When using multiple coils each coil could be powered simultaneously or separately to decrease the required power, sterilize or disinfect/decontaminate at different times, or other reasons that may be beneficial to operation. The material of the outside surface element here may be selected from such conductive materials that are well known to be effective in inductive heating applications, such as aluminum, copper, steel, stainless steel, nickel; but most beneficially ferrous alloys such as stainless steel that have high magnetic permeability.

In yet another embodiment, the outside surface element is constructed of a material that undergoes a significant exothermic reactive process when induced to do so by another mechanism at the time of assembly. In one specific embodiment, the outside surface element consists of a reactive multi-layer foil (in the more general class of pyrotechnic initiators) that is triggered to undergo a self-sustaining exothermic reaction. This trigger may be supplied by a laser, electric spark, or the application of a sufficient current and/or voltage to one area of the surface element. The self-sustaining exothermic reaction may be selected or designed (through the nature of the geometry and/or materials of the reactive multi-layer foil) to produce sufficient heat to enable the rapid attainment and/or maintenance of target temperature (if and as required) to perform the desired sterilization or bioburden reduction. In a more specific embodiment, the reactive multi-layer foil may be a set of sputtered nanoscale layers of aluminum and nickel, which are commercially available from Indium Corporation (Utica, N.Y.) under the trade name Nanofoil.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a drug container and access assembly each incorporating a sterile seal heated through ohmic heating in accordance with an embodiment of the disclosure.

FIG. 2 is an exploded perspective view of the drug container of FIG. 1.

FIG. 3 is an exploded perspective view of the access assembly of FIG. 1.

FIG. 4A is a perspective view of the illustrative foil of FIG. 2.

FIG. 4B is a perspective view of an alternative illustrative foil.

FIG. 5 is a graph illustrating the time vs temperature result of ohmic heating of a foil in accordance with FIG. 4A.

FIGS. 6 and 7 are graphs illustrating the time vs temperature result of ohmic heating of a foil in accordance with FIG. 4B.

FIG. 8 is a perspective view of a drug container and access assembly each incorporating a sterile seal heated through induction heating in accordance with an embodiment of the disclosure.

FIG. 9 is an exploded perspective view of the drug container of FIG. 8.

FIG. 10 is an exploded perspective view of the access assembly of FIG. 8.

FIG. 11 is a graph illustrating the time vs temperature result of induction heating of the foil of FIG. 8.

FIG. 12 is a perspective view of a drug container and access assembly each incorporating a sterile seal heated through exothermic reaction in accordance with an embodiment of the disclosure.

FIG. 13 is an exploded perspective view of the drug container of FIG. 12.

FIG. 14 is an exploded perspective view of the access assembly of FIG. 12.

FIG. 15 is a perspective view of an activation assembly of the embodiment of FIG. 12.

FIG. 16 is a partially exploded view of a cartridge assembly and access cap each incorporating a sterile seal in accordance with an embodiment of the disclosure.

FIGS. 17 and 18 are side elevation views sequentially illustrating connection of the access cap to the cartridge assembly of FIG. 16.

FIG. 19 is a perspective view of a tubing housing and needle housing each incorporating a sterile seal in accordance with an embodiment of the disclosure.

FIG. 20 is an exploded perspective view of the tubing housing of FIG. 19.

FIG. 21 is an exploded perspective view of the needle housing of FIG. 19.

FIGS. 22A, 22B and 22C are side elevation views sequentially illustrating connection of the needle housing to the tubing housing of FIG. 19.

### DETAILED DESCRIPTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

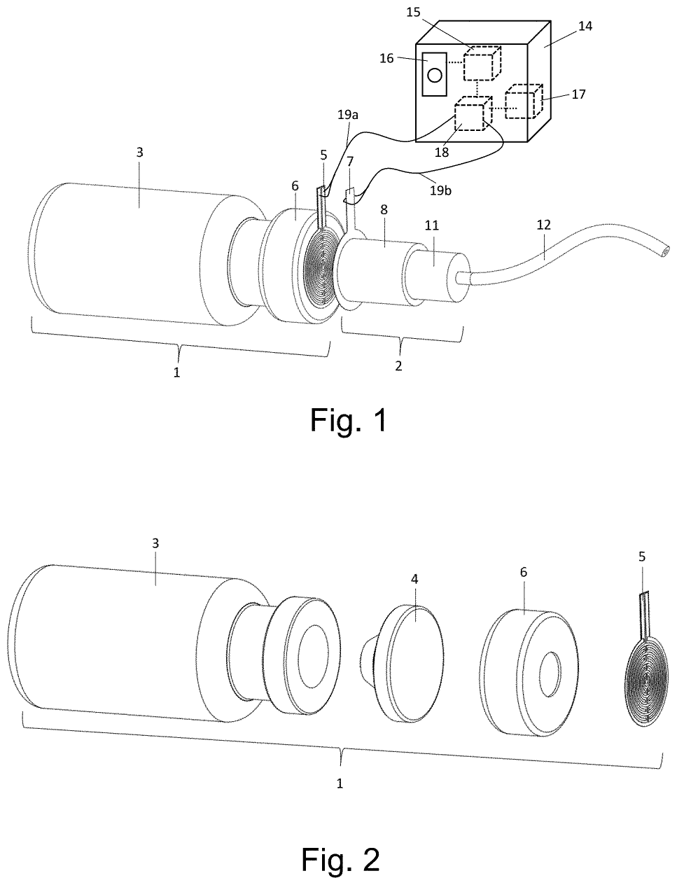

Referring to FIG. 1, an illustrative embodiment of the disclosure that uses direct electrical contact and the application of an electrical current to generate heat through Joule Heating or Ohmic Heating and thereby provide a sterile or disinfected/decontaminated connection path will be described. In this embodiment, a drug container 1 is configured for connection to access assembly 2. Access assembly 2 provides a means to connect tubing 12 to drug container 1 through the pushing together of the two assemblies. This motion will force needle 9 into drug container 1 through a path made sterile or disinfected/decontaminated by Joule Heating or Ohmic Heating to allow for drug delivery. The end of tubing 12 can be connected to a subcutaneous needle or other drug delivery mechanism. While a needle is shown and described, any penetrating member that cuts through, cuts away, or otherwise removes the foil may be used, for example, a cannula, a spike, a pin, a blade or the like.

Drug container 1 and access assembly 2 are manufactured such that all surfaces within the internally sealed volume of drug container 1 and access assembly 2 are sterile and maintained sterile up to the time of use. Once removed from the manufacturing environment, which may be sterile or aseptic, the outer surfaces of drug container 1 and access assembly 2 can no longer be claimed as sterile. Prior to use foil 5 and foil 7 are heated through Joule Heating or Ohmic Heating by direct electrical contact and the application of an electrical current to provide a sterile or disinfected/decontaminated connection path.

FIG. 1 shows an illustrative activation assembly 14 configured to provide electrical current to foils 5, 7. Activation assembly 14 is configured for connection to contacts 13a, 13b on foils 5, 7 (see FIG. 4A), for example, via connection wires 19a, 19b which are connected to energy source 17. Energy source 17 may be a battery, direct or alternating current, or any other desired energy source. In the illustrated embodiment, boost converter/regulator 18 is positioned between the energy source 17 and the connection wires 19, 19b. Microcontroller 15 is connected to the boost converter/regulator 18 such that a user may control the timing, power and the like delivered through connections wires 19a, 19b via control panel 16. Other assemblies may be utilized to selectively control current and/or voltage delivered to the activation of foils 5, 7.

FIG. 2 shows an exploded view of drug container 1. The assembly process and design of container 1 is common with those typically used in the industry. Septum 4 is used to seal the open face of vial 3 and is held closed by crimping cap 6 to vial 3. Foil 5 is attached to the outer surface of cap 6 and forms a hermetic seal between the two components. FIG. 2 shows foil 5 attached to the outer surface of cap 6 but could also be assembled to the inner surface of cap 6 and compressed against septum 4 in a differing embodiment.

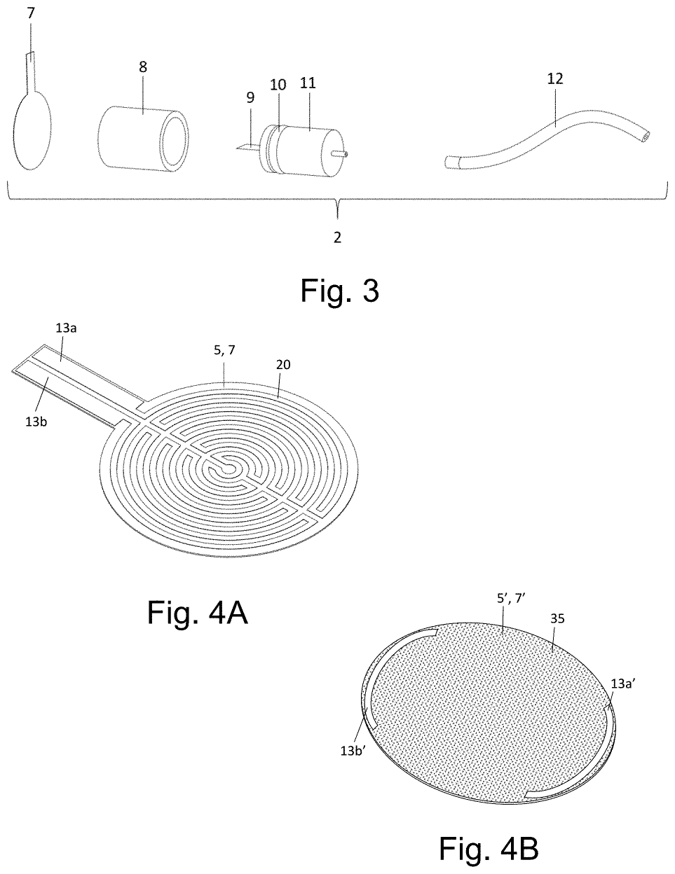

FIG. 3 shows an exploded view of access assembly 2 which allows for the insertion of needle 9 into drug container 1. Access assembly 2 is made up of housing 8 which is sealed at both ends and manufactured such that the internally sealed volume is sterile. One side of housing 8 is sealed using foil 7 which is attached in a hermetic fashion. The opposing side of housing 8 is sealed using needle holder 11. Needle holder 11 creates a seal with housing 8 using seal 10. Seal 10 creates a hermetic seal within the bore of housing 8 while allowing needle holder 11 to slide axially within housing 8. This sliding motion allows the insertion of needle 9, which is rigidly attached to needle holder 11, through foil 7, foil 5, and septum 4 to gain access to the internal volume of drug container 1. In another embodiment needle 9 and needle holder 11 could be combined into one component using an injection molded spike design as is commonly done in the industry. Tubing 12 is attached to the non-piercing end of needle 9 and can be coupled to a subcutaneous needle or other drug delivery method.

FIG. 4A shows a detailed view of one embodiment of foil 5, 7. As electrical current passes through conductor 20 along foil 5, 7 it develops heat through a process known as Joule Heating or Ohmic heating, a process in which a conductor develops heat due to the passage of an electric current. In the illustrated embodiment, conductor 20 on foil 5, 7 is designed such that current passes in a circuitous path through the foot print of the component and uniformly creates heat. A small gap in the current pathway is left in the middle of the foil to allow for the needle to more easily puncture. Foils 5 and 7 are shown in this embodiment with the same geometry, but each part could be customized for its specific requirements. In this embodiment, foil 5, 7 is created by using a thermoset adhesive to bond an etched conductor geometry between two polyimide substrates. This embodiment uses a stainless-steel conductor, but other conductive materials such as steel, aluminum, copper, nickel, nichrome, etc., or ceramics like silicon carbide, molybdenum disilicate can also be used in differing embodiments. Differing materials and assembly methods can also be used to bond the conductor as well.

FIG. 4A shows one embodiment of an ohmic heating foil, but others could be created by those skilled in the art. When current is passed through a conductive material it will generate heat such that any electrically conductive material and geometry that can be pierced by a needle could act as alternate embodiment for what is shown in FIG. 4A.

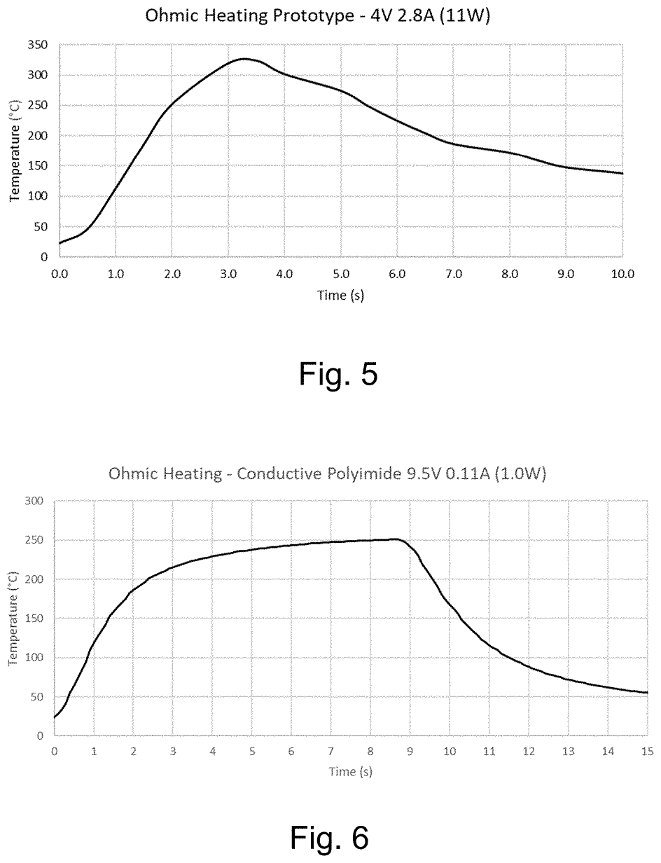

FIG. 5 shows the temperature vs time data of a prototype ohmic heating foil when 11-watts of power is supplied for approximately 3.5 seconds. The sample was run at room temperature conditions and temperature was measured with a thermocouple. FIG. 5 shows the prototype embodiment's ability to quickly rise in temperature by reaching 300° C. in under 3 seconds. The heating profile of FIG. 5 is one example of a heating time & temperature that can be implemented using this method. Other temperatures for other durations can also be sustained based on the requirement. Microbial decontamination, bioburden reduction, disinfection (whether generally or of specific species of bacteria/virus/fungi), and sterilization (to a specific Sterility Assurance Level) each could require a different mean or peak temperature and duration over which that should be held. The strictest application in medical devices is typically the case of sterilization to a Sterility Assurance Level of 10′, using an Overkill Approach as defined, for example, in ISO 20857. This is generally equivalent to the demonstration of a 12-log (that is, a factor of 10¹²) extrapolated reduction in the population of the Most Resistant Organism (MRO) for this process; for dry heat sterilization, this is generally accepted to be spores of Bacillus atrophaeus. The time to perform a 12-log reduction for this MRO varies significantly by temperature, traditionally determined using two coefficients called the D-value and Z-value. The D-value is the length of time under specified conditions (here, strictly temperature) required to reduce the microorganism population by 90% (one log reduction). The Z-value is the increase in temperature required to reduce the D-value by 90% (reduce by a factor of 10). Assuming a typical Z-value of 30° C. and typical D-value at 160° C. of 3 minutes, the 12-log reduction takes approximately 40 minutes at 160° C., approximately 100 seconds at 200° C., approximately 10 seconds at 230° C., approximately 2 seconds at 250° C., approximately 0.5 seconds at 270° C. and a small fraction of a second at 300° C. For this process, then, there is the opportunity for very rapid sterilization times provided that the process can quickly achieve >250° C. and that the materials of construction can handle the process under those conditions. Referring again to FIG. 5, this example plot shows a temperature of >250° C. maintained for >2 seconds, so this example profile is more than sufficient to achieve the requirements of Overkill Sterilization while only taking several seconds. In applications where a lesser effort is required, such as in decontamination or disinfection, the process can occur even more rapidly or can be executed at lower peak temperatures (and thus needing less power and/or stored energy). Also, where the foil materials as well as the materials contacting the foils have a lower maximum allowable temperature, the process can be executed at a lower temperature. For example, at 230° C. the process is still quite rapid and can be executed in well under a minute. In many applications, the sterilization, disinfection, or decontamination time is not critical, and more time can be allowed for the process. In that case, peak temperatures as low as 200° C. can still permit the execution of the process in several minutes. Certain other applications may require the decontamination or disinfection of a surface where there is very low or no risk of the presence of the Most Resistant Organism (Bacillus atrophaeus), or where the objective is only the reduction or elimination of less-resistant bacteria, viruses, fungi, prions, etc. In this case, the required time or temperature may be reduced even further based on the characteristics of these decontamination targets. Conversely, in other applications, there may arise the need to decontaminate or sterilize a surface or surfaces where a microorganism or other microbiological substance has been shown to be even more resistant to heat than the standard Most Resistant Organism (Bacillus atrophaeus). In those cases, the time and/or temperature of the process can be extended as required and as materials permit based on the characteristics of these decontamination targets.

Referring to FIG. 4B, another embodiment for an Ohmic Heating foil 5′, 7′ uses a polymer film that is filled with metal powders, ceramic powders, graphite, carbon black, or other conductive materials 35 to create a substrate that is electrically and thermally conductive. One such example would be an alumina-filled PTFE polytetrafluoroethylene filled with Al2O3 micro- or nano-particles and extruded into a film). Another would be polyimide filled with graphite or carbon powder and formed into a film. These materials may have additional film layers that are unfilled or filled to a different level. For example, the filled polyimide may be coextruded with an unfilled layer of polyimide to provide preferred mechanical properties such as tensile strength and tear resistance. One such example material is Kapton RS, a carbon filled polyimide, marketed and manufactured by Dupont Electronics.

As shown in FIG. 4B, the geometric configuration shown in FIG. 4A need not apply. Instead, the entire conductive film 5′, 7′ serves as a uniform surface resistor with no need for elaborate traces. Two contact points 13a′, 13b′ or lines at opposed areas of the foil 5′, 7′ are sufficient to provide a current through the part, which will result in near-uniform heating across this component. Furthermore, more elaborate contact designs can be constructed to focus the heat and thus temperature rise into certain areas of the component. The near-uniform heating can be used to produce a near-uniform temperature profile across the entire region of foil 5′ and foil 7′ that could be pierced by needle 9, assuring the maintenance of sterility across variations in component and assembly tolerances.

The material and amount of the conductive filler 35 of foil 5′, 7′ can be selected to provide a target electrical resistivity level or sheet resistance level. By selecting a preferred target level, the required voltage and power to achieve the sterilization or disinfection/decontamination target can be reduced. This may be advantageous for portable or wireless devices, where the power and voltage may come from a stored electrical energy source such as a battery. In those cases, limiting the required power and/or voltage may enable lower cost and/or cheaper devices. In the example of the carbon-filled polyimide product Kapton RS, the sheet resistance is nominally 100 Ohms, a level that can achieve the required heating with voltages typical of battery sources for foils 5′ and 7′ on the scale of several millimeters to a couple centimeters in diameter.

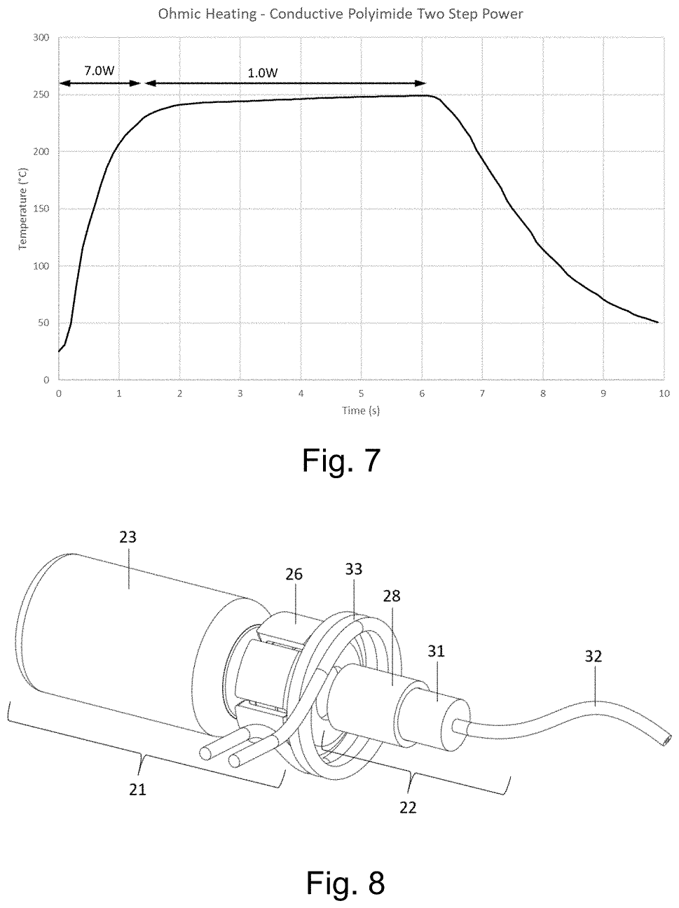

FIG. 6 shows the temperature vs time data of a prototype ohmic heating foil 5′, 7′ consisting of carbon-filled polyimide of approximately 1 cm in diameter, when powered with a constant voltage of 9V. A sufficiently high temperature (230-250° C.) is developed for a sufficient duration of time (in the range of 2 to 10 seconds for temperatures ranging, respectively, from 250° C. to 230° C. as discussed previously) to achieve a 12-log reduction of bioburden (sterilization) while requiring much less power and energy than the results shown in FIG. 5. In FIG. 6, the power supply is initiated to the foil at time=0 seconds and is stopped at time=8.5 seconds. The temperature rises steadily and then exponentially levels off to a near steady state temperature. The sterilization or disinfection process can be significantly accelerated with a slight reduction in efficiency by supplying a much higher power to the foil initially, followed by a reduction to a lower power level once the target temperature is nearly reached. This is shown in FIG. 7, where 7 W are applied for the first 1.3 seconds, falling to 1 W for a further 4.7 seconds; this contrasts the input of 1 W for 8.5 seconds shown in FIG. 7. The result of a two-step power input, as evidenced in comparing the two figures, is an acceleration to the target temperature and a shorter duration from initiation until the completion of the target sterilization or disinfection. Additional variations in power, such as three or more power levels or a continuously varying power level, may be employed to get the temperature profile even closer to an ideal square wave; these alternate means of variations in power may alternately be employed to improve the efficiency of the process or optimize the life or efficacy of the power source.

Referring to FIG. 8, an illustrative embodiment that generates heat through Induction Heating to provide a sterile or disinfected/decontaminated connection path will be described. Again, drug container 21 is configured for connection to access assembly 22. Access assembly 22 provides a means to connect tubing 22 to drug container 21 through the pushing together of the two assemblies. This motion will force needle 29 (FIG. 10) into drug container 21 through a path made sterile or disinfected/decontaminated by Induction Heating to allow for drug delivery. The end of tubing 32 can be connected to a subcutaneous needle or other drug delivery mechanism.

Drug container 21 and access assembly 22 are manufactured such that all surfaces within the internally sealed volume of drug container 21 and access assembly 22 are sterile. Once removed from the manufacturing environment, which may be sterile or aseptic, the outer surfaces of drug container 21 and access assembly 22 can no longer be claimed as sterile nor maintained sterile up to the time of use. Prior to use, foil 25 and foil 27 are heated through Inductive Heating to provide a sterile or disinfected/decontaminated connection path. For example, the foils 25, 27 may be connected to activation assembly 14 and a high frequency alternating current is passed through coil 33 to produce an alternating electromagnetic field around coil 33. This electromagnetic field induces eddy currents in foil 25 and foil 27 which are made of electrically conductive material. These eddy currents rapidly heat foil 25 and foil 27, through Induction Heating, to provide a sterile or disinfected/decontaminated connection path for needle 29 to pass into drug container 21.

FIG. 8 shows an illustrative embodiment of coil 33. Induction coils can take multiple different shapes other than the coil geometry shown. The coil geometry, diameter, number of coils, and wire diameter can all be varied to optimize the design for the application. A flat coil design can also be used and placed between drug container 21 and access assembly 22.

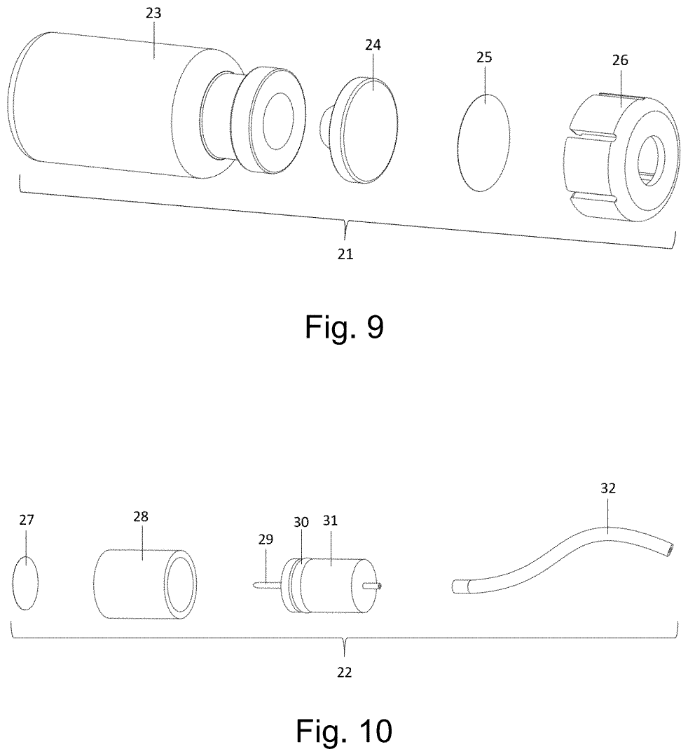

FIG. 9 shows an exploded view of drug container 21. Septum 24 is used to seal the open face of vial 23. Foil 25 is placed on top of septum 24 and locked in a compressed state by snapping cap 26 onto vial 23. In this specific embodiment vial 23, septum 24, and cap 26 are made of non-electrically conductive materials to prevent ohmic heating when exposed to alternating electromagnetic fields induced by coil 33. In an alternate embodiment, cap 26 could be made of an electrically conductive material. The material and geometry of cap 26 and the frequency at which coil 33 is driven could be selected such that it is less prone to inductive heating in relation to foil 25 to promote heating of foil 25 over cap 26.

FIG. 10 shows an exploded view of access assembly 22 which allows for the insertion of needle 29 into drug container 21. Access assembly 22 is made up of housing 28 which is sealed at both ends to create an internally sealed volume that is sterilized during the assembly process. One side of housing 28 is sealed using foil 27 which is attached in a hermetic fashion. The opposing side of housing 28 is sealed using needle holder 31. Needle holder 31 creates a seal with housing 28 using seal 30. Seal 30 creates a hermetic seal within the bore of housing 28 while allowing needle holder 31 to slide axially within housing 28. This sliding motion allows the insertion of needle 29, which is rigidly attached to needle holder 31, through foil 27, foil 25, and septum 24 to gain access to drug container 21. In another embodiment needle 29 and needle holder 31 could be combined into one component using an injection molded spike design as is commonly done in the industry. Tubing 32 is attached to the non-piercing end of needle 29 and can be coupled to a subcutaneous needle or other drug delivery method. Housing 28, seal 30, and needle holder 31 are made of non-electrically conductive materials to prevent Inductive Heating when exposed to alternating electromagnetic fields.

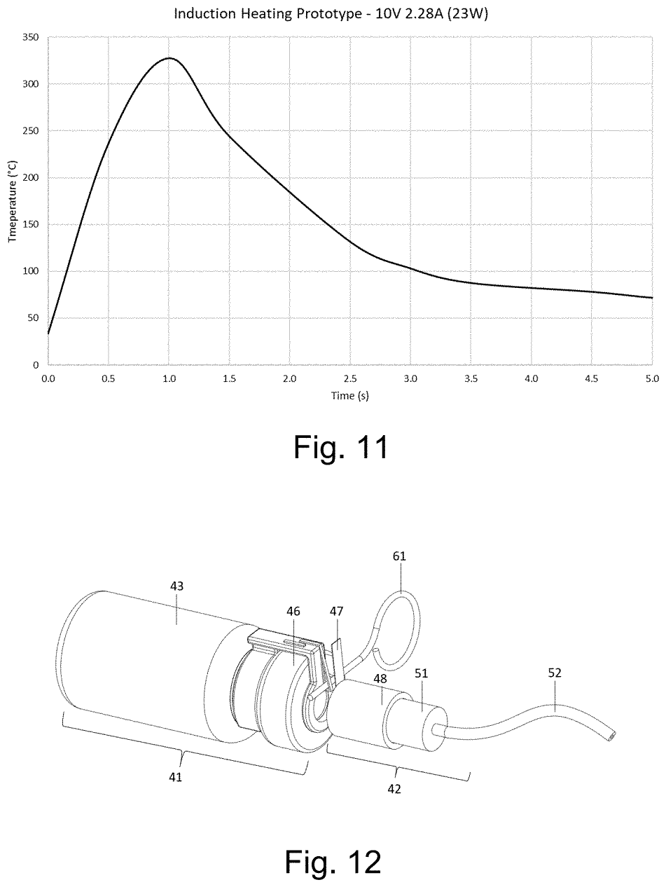

FIG. 11 shows the temperature vs time data of a prototype foil 25, 27 when placed in a prototype induction coil supplied with 23 watts for approximately 1 second. The sample was run at room temperature conditions and temperature was measured with a thermocouple. FIG. 11 shows the prototype embodiment's ability to quickly rise in temperature by reaching 300° C. in under 1 second.

From the analysis and conclusions of the paragraph above considering the microbicidal performance of FIG. 5, it can be readily observed that the temperature profile of FIG. 11 likewise is more than sufficient to achieve the requirements of Overkill Sterilization by exceeding 300° C. for a substantial fraction of a second. Thus FIG. 11 shows the induction heating capability of sterilizing in an even more rapid fashion than the example Ohmic Heating temperature profile given in FIG. 5. In applications where a lesser effort is required, such as in decontamination or disinfection, the process can occur even more rapidly or can be executed at lower peak temperatures (and thus needing less power and/or stored energy).

Referring to FIG. 12, an illustrative embodiment that uses an outside surface constructed of a material that undergoes a significant exothermic reactive process when induced to do so by another mechanism at the time of use to provide a sterile or disinfected/decontaminated connection path will be described. The specific embodiment shown makes use of an outside surface constructed of a multi-layer foil 45, 47 that is triggered to undergo a self-sustaining exothermic reaction. Again, the invention is illustrated with a drug container 41 configured for connection to access assembly 42. Access assembly 42 provides a means to connect tubing 52 to drug container 41 through the sterile or disinfected/decontaminated connection path and allow for drug delivery. This motion will force needle 49 into drug container 41 through a path made sterile or disinfected/decontaminated by a significant exothermic reactive process to allow for drug delivery. The end of tubing 52 can be connected to a subcutaneous needle or other drug delivery mechanism.

Drug container 41 and access assembly 42 are manufactured such that all surfaces within the internally sealed volume of drug container 41 and access assembly 42 are sterile. Once removed from the manufacturing environment, which may be sterile or aseptic, the outer surfaces of drug container 41 and access assembly 42 can no longer be claimed as sterile nor maintained sterile up to the time of use. Prior to use, foil 45 and foil 47 are activated and undergo a self-sustaining exothermic reaction to provide a sterile or disinfected/decontaminated connection path. Foil 45 and foil 47 can be activated by exposure to heat, laser, impact, the application of a sufficient current and/or voltage, or other forms of concentrated energy.

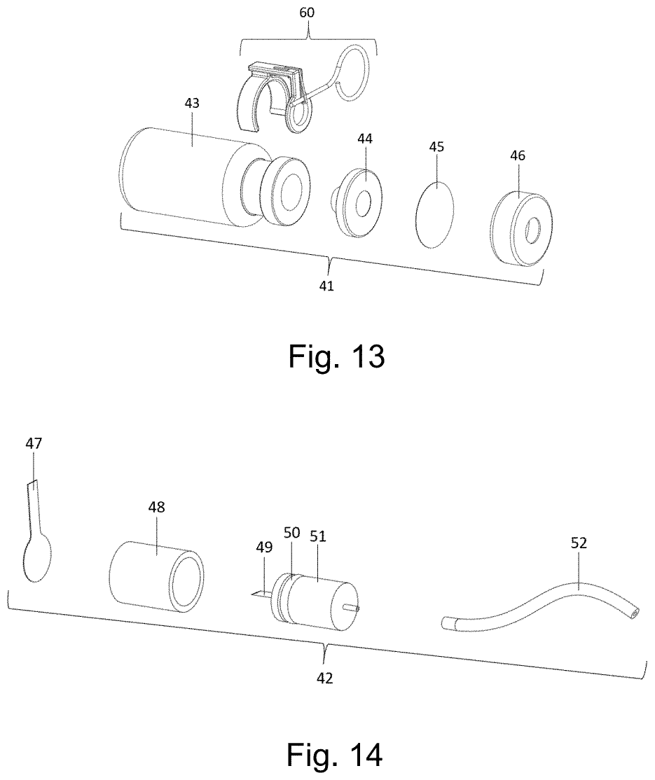

FIG. 13 shows an exploded view of drug container 41. The assembly process and design of drug container 41 is common with those typically used in the industry. Septum 44 is used to seal the open face of vial 43. Foil 45 is placed on top of septum 44 and is held closed by crimping cap 46 to vial 43. Activation assembly 60 is then clipped onto the neck of vial 43.

FIG. 14 shows an exploded view of access assembly 42 which allows for the insertion of needle 49 into drug container 41. Access assembly 42 is made up of housing 48 which is sealed at both ends and manufactured such that the internally sealed volume is sterile. Once removed from the manufacturing environment, which may be sterile or aseptic, the outer surfaces of access assembly 42 can no longer be claimed as sterile. One side of housing 48 is sealed using foil 47 which is attached in a hermetic fashion. The opposing side of housing 48 is sealed using needle holder 51. Needle holder 51 creates a seal with housing 48 using seal 50. Seal 50 creates a hermetic seal within the bore of housing 48 while allowing needle holder 51 to slide axially within housing 48. This sliding motion allows the insertion of needle 49, which is rigidly attached to needle holder 51, through foil 47, foil 45, and septum 44 to gain access to drug container 41. In another embodiment needle 49 and needle holder 51 could be combined into one component using an injection molded spike design as is commonly done in the industry. Tubing 52 is attached to the non-piercing end of needle 49 and can be coupled to a subcutaneous needle or other drug delivery method.

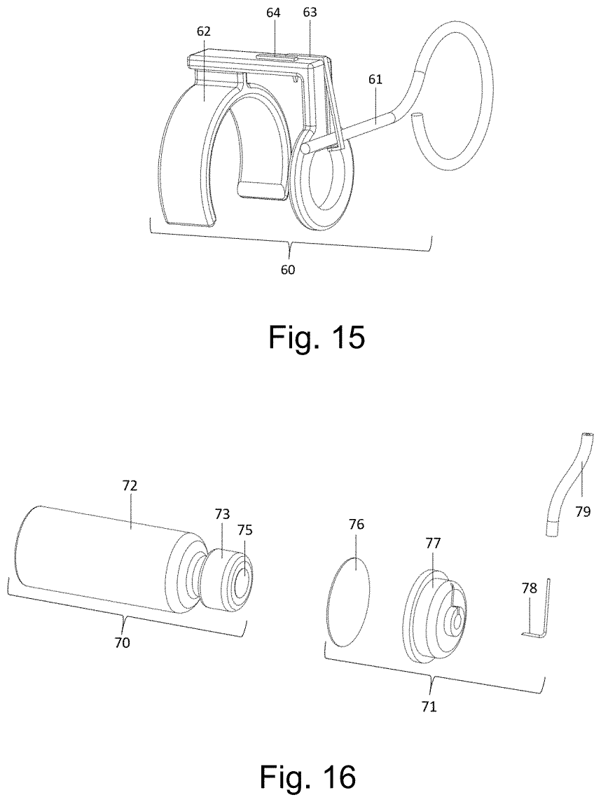

FIG. 15 shows an illustrative embodiment of an activation assembly 60 to activate the exothermic reactive process of foil 45 through the use of an electric spark. A similar activation assembly 60 may be utilized with foil 47. Activation assembly 60 is clipped onto drug vial 41 using clip 62. Clip 62 houses negative contact 64 and positive contact 63. In this embodiment the names of negative contact 64 and positive contact 63 are assigned arbitrarily and only signify that each contact has a differing electrical potential. Positive contact 63 and negative contact 64 are constructed of an electrically conductive material and supplied with differing electrical potentials. Negative contact 64 is held in direct contact with cap 46. Cap 46 is constructed of an electrically conductive material, aluminum in this specific embodiment although other conductive materials could be used, that allows negative contact 64 to electrically short to foil 45, through cap 46, when assembled to drug vial 41. Positive contact 63 is normally positioned in a down state that will allow contact with foil 45 but is held in an elevated state by release 61 while stored. A user interaction will initiate the removal of release 61 and allow positive contact 63 to spring into its free state and contact foil 45. The differing electrical potentials of negative contact 64 and positive contact 63 will result in a spark between foil 45 and positive contact 63. This spark activates the exothermic reactive process of foil 45 that rapidly heats foil 45 converting it to a sterile or disinfected/decontaminated state.

FIG. 15 shows on specific embodiment of a method to activate foil 45, 47. Reactive multi-layer foils, such as those used for foil 45 and foil 47 can also be activated by exposure to heat, laser, impact, the application of a sufficient current and/or voltage, or other forms of concentrated energy. Additionally, while a reactive Ni/Al multi-layer foil is described, other exothermic reactive materials may be utilized. For example, U.S. Pat. No. 6,534,194 discloses, in addition to the Ni/Al multi-layer foil, a multi-layer foil may be made from alternating layers of Al/CuO. As yet another embodiment, such an exothermic reactive material may comprise sheets of Al, Ni, Cu, Ti, Zr, or Hf, or alloys of Ni—Cu or Ti—Zr—Hf. As yet another example, US Pat. Appln. Pub. No. US2007/0018774A1 explains that other initial reactants and their resulting reaction products may include: titanium (Ti) and boron (B), and titanium boride (TiB2); zirconium (Zr) and boron, and zirconium boride (ZrB2); hafnium (Hf) and boron, and hafnium boride (HfB2); Ti and carbon (C), and titanium carbide (TiC); Zr and carbon, and zirconium carbide (ZrC), Hf and carbon, and hafnium carbide (HfC); Ti and silicon (Si) and Ti5Si3; Zr and silicon, and Zr5Si3; niobium (Nb) and silicon, and Nb5Si3; Zr and Al, and ZrAl; lead (Pb) and Al, and PbAl. Application of an energy source to the nano-layers in their initial state results in a self-propagating exothermic reaction and an intermetallic reaction product. As another alternative, US Pat. Appln. Pub. No. US2010/0032064A1 describes the creation of reactive nano-scale multi-material metal particles, as opposed to foils. As described therein, these particles could be applied/adhered to a substrate and then activated. Each of these documents is incorporated herein by reference.

In contrast to the principle of sterilizing/disinfecting/decontaminating operation of the Ohmic Heating and Inductive Heating methods described above, the reactive foil does not have a time/temperature profile that is controlled by means of a supply voltage and/or current for a particular amount of time. Rather, the reactive foil is initiated and then the surface is heated for the duration of the exothermic reaction. The peak temperature can be made much higher than for the other methods; for example, Indium reports that the surface temperature of NanoFoil™ (a reactive Ni/Al multi-layer foil) reaches temperatures >1300° C. when used at room temperature. At this extremely high temperature, the time duration is less relevant and microbial inactivation occurs simply through the exposure of the surface to the extreme temperature. If a higher or lower peak temperature is desired, either to limit damage to adjacent components of the product or to better optimize sterilization characteristics, this can be achieved through modification of the nanoscale geometry of the reactive foil and/or substituting other constituent materials (versus, for example, Aluminum and Nickel) in the reactive foil.

FIG. 16 shows an alternative embodiment to a method of making a connection between a drug container and a fluid path. In this embodiment, cartridge assembly 70 is configured for connection to access cap 71. While described as a cartridge assembly, the assembly may have other configurations, for example, a vial assembly. Cartridge assembly 70 is made up of cartridge 72 that is sealed at one end with septum 74. Foil 75 is placed between septum 74 and cap 73 and held in a compressed state by the crimping of cap 73 onto cartridge 72. Access cap 71 provides a means of connecting tubing 79 to cartridge assembly 70. Access cap 71 is made up of needle cap 77 that is sealed at one end by foil 76 that is attached in a hermetic fashion. Needle cap 77 is sealed at the opposing end by gluing needle 78 into needle cap 77.

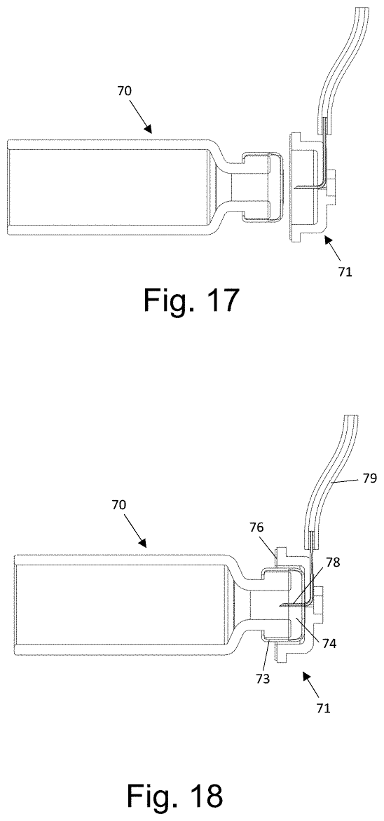

FIG. 17 shows cartridge assembly 70 and access cap 71 in a pre-connected state. In this state, any of the sterilization methods or disinfection/decontamination methods discussed above, i.e. Joule Heating or Ohmic Heating, Induction Heating, or exothermic reaction, could be used to provide a sterile or disinfected/decontaminated connection through foil 75 and foil 76.

FIG. 18 shows cartridge assembly 70 and access cap 71 in a post-connected state. To connect cartridge assembly 70 and access cap 71, the two components are pushed together. This pushing motion forces cap 73 to pierce foil 76 and allow needle 78 to penetrate foil 75 and septum 74 and create a path for drug product to flow from cartridge assembly 70, through tubing 79 to a subcutaneous needle or other drug delivery mechanism.

As described to this point the differing embodiments of this invention have been shown connecting a drug cartridge or vial to a portion of tubing. This is only one potential use of this invention and many others exist where there is a need to make a sterile connection between two disconnected components. One potential use of any of the embodiments described above is to provide a sterile or disinfected/decontaminated connection path between two separate lengths of flexible tubing. A second alternative use to this invention is to provide a sterile or disinfected/decontaminated connection path to allow for fluid transfer between two separate syringes, cartridges, bags, or other pairs of sterile fluid containers or conduits. In either of these alternative uses, each mating surface that requires a connection to an opposing mating surface could be sealed by a conductive foil that can be heated by means of Joule Heating or Ohmic heating, a metallic foil capable of being heated through Induction Heating, or an outside surface element constructed of a material that undergoes significant exothermic reactive process when induced to do so by another mechanism.

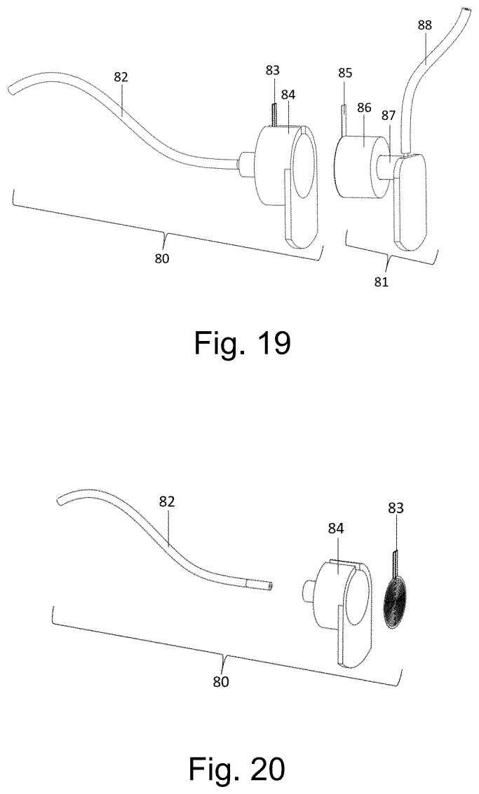

FIG. 19 shows an alternative use and embodiment of using Joule Heating or Ohmic heating to provide a sterile or disinfected/decontaminated connection path between two separate lengths of flexible tubing. Flexible tubing can be flexible or rigid tubing. The invention allows for the connection of tubing 82 to tubing 88 through the pushing together of tubing housing 80 and needle housing 81. This motion will force needle 90 into the inner diameter of tubing 82 through a path made sterile or disinfected/decontaminated by Joule Heating or Ohmic Heating.

The embodiment shown in FIG. 19 uses Joule Heating or Ohmic Heating to create a sterile or disinfected/decontaminated connection path. This could also be achieved by creating heat using Induction Heating or a foil constructed of a material that undergoes a significant exothermic reactive process when induced to do so by another mechanism at the time of assembly as described in the paragraphs above.

Tubing housing 80 and needle housing 81 are manufactured such that all surfaces within the internally sealed volume of tubing housing 80 and needle housing 81 are sterile and maintained sterile up to the time of use. Once removed from the manufacturing environment, which may be sterile or aseptic, the outer surfaces of tubing housing 80 and needle housing 81 can no longer be claimed as sterile. Prior to use, foil 83 and foil 85 are heating through Joule Heating or Ohmic Heating by direct electrical contact and the application of an electrical current to provide a sterile or disinfected/decontaminated connection path.

FIG. 20 shows and exploded view of tubing housing 80. Foil 83 is attached to the outer surface of tubing holder 84 and forms a hermetic seal between the two components. Tubing 82 is attached in a hermetic fashion to tubing holder 84 and sealed at its other end, which is shown as open in FIG. 19. The opposing end of tubing 82 can be attached to any device that requires a sterile or disinfected/decontaminated connection path to another length of flexible tubing.

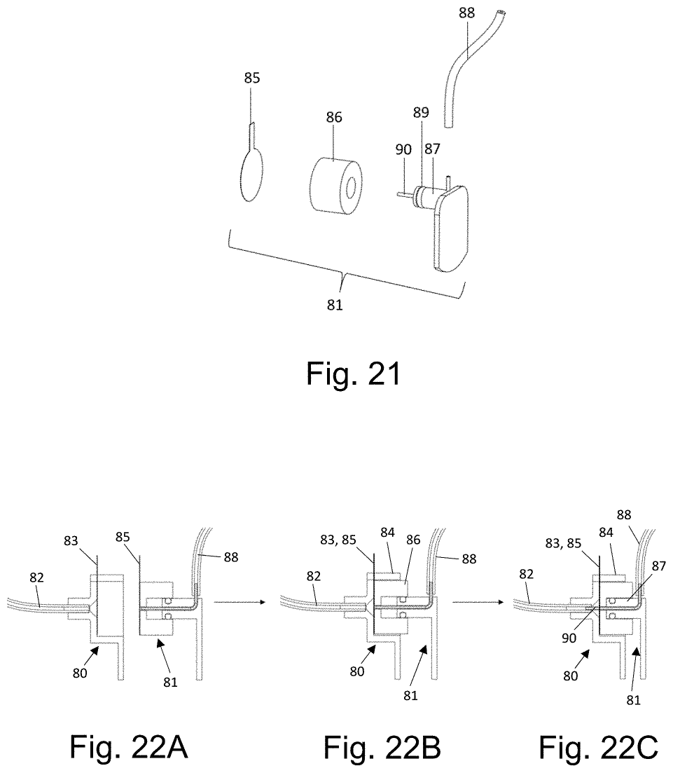

FIG. 21 shows an exploded view of needle housing 81 which allows for the insertion of needle 90 into tubing housing 80 and tubing 82. Needle housing 81 is made up of needle case 86 which is sealed at both ends and manufactured such that the internally sealed volume is sterile. One side of needle case 86 is sealed with foil 85 which is attached in a hermetic fashion. The opposing side of needle case 86 is sealed using needle holder 87. Needle holder 87 creates a seal with needle case 86 using seal 89. Seal 89 creates a hermetic seal within the bore of needle case 86 while allowing needle holder 87 to slide axially within needle case 86. This sliding motion allows the insertion of needle 90, which is rigidly attached to needle holder 87, through foil 85, foil 83, and into tubing 82. Tubing 88 is attached in a hermetic fashion to needle holder 87 and sealed at its other end, which is shown as open. The opposing end of tubing 88 can be attached to any device that requires a sterile or disinfected/decontaminated connection path to another length of flexible tubing.

FIGS. 22A-22C show the step by step function of the connection of tubing 82 to tubing 88. FIG. 22A shows the pre-assembly state with tubing housing 80 and needle housing 81 separated by a distance as they would be prior to use. FIG. 22B shows the mid-assembly state with the brining together of tubing housing 80 and needle housing 81, by sliding needle case 86 into tubing holder 84. At this state foil 83 and foil 85 can be made sterile or disinfected/decontaminated by direct electrical contact and the application of an electrical current to generate heat through Joule Heating or Ohmic Heating. The Joule Heating or Ohmic Heating step can also be conducted prior to the assembly of needle case 86 into tubing holder 84. Again, this could also be achieved by creating heat using Induction Heating or a foil constructed of a material that undergoes a significant exothermic reactive process when induced to do so by another mechanism at the time of assembly as described in the paragraphs above. The assembled state is shown in FIG. 22C and is achieved by pressing needle holder 87 against tubing holder 84 which presses needle 90 through foil 85 and foil 83 and into tubing 82, thus creating a sterile or disinfected/decontaminated flow path from tubing 82 to tubing 88. The pressing of needle holder 87 against tubing holder 84 could be done manually by the user or automatically through and external device.

The method of creating a sterile or disinfected/decontaminated flow path between two lengths of flexible tubing described in the paragraphs above is a vast improvement over what is typically done today to make these types of connections. This method requires minimal user dexterity and the sterilization or disinfection/decontamination process is done automatically as opposed to manual processes, such as disinfecting through the application of isopropyl alcohol, that present increased risk of human error. This method also eliminates the need of an aseptic environment or specially configured sterilization equipment to make the connection. Additionally, alternate approaches may involve the use of a chemical sterilant/disinfectant that may contaminate or otherwise impact the purity, cleanliness and/or efficacy of the contents of the containers or tubes to be connected. The methods described herein, unlike other heating approaches, do not burn up, burn away, or melt away containing surfaces and minimize the risk of creating and/or spreading reaction products or residues to potentially impact the purity, cleanliness and/or efficacy of the contents of the containers or tubes to be connected.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. A sterile access member for a container or conduit having an opening into a sterile area within the container or conduit, the sterile access member comprising:
a foil positioned over and sealing the opening, the foil configured such that activation thereof causes at least a portion of the foil to automatically heat to a desired temperature for a desired time such that the heated portion of the foil has reached a desired sterile state.

2. The sterile access member according to claim 1 wherein the foil is activated through ohmic heating or Joule heating.

3. The sterile access member according to claim 2 wherein the foil has a conductor applied to a surface thereof and defining a current path.

4. The sterile access member according to claim 2 wherein the foil is a polymer film containing metallic powders, ceramic powders, graphite, carbon black and/or other conductive materials within the polymer film.

5. The sterile access member according to claim 1 wherein the foil is activated through induction heating.

6. The sterile access member according to claim 5 wherein inductive heating is achieved through the application of a current through an induction coil positioned adjacent to the foil.

7. The sterile access member according to claim 1 wherein the foil is made from an exothermic reactive material.

8. The sterile access member according to claim 7 wherein the exothermic reactive material comprises an arrangement of layers or particles of metals that upon activation undergo an exothermic reaction without any other reagents or products.

9. The sterile access member according to claim 7 wherein the foil is activated through exposure to heat, application of an electric spark, laser, impact, or the application of a sufficient current and/or voltage.

10. The sterile access member according to claim 1 wherein the desired temperature and the desired time are sufficient to achieve disinfection and/or decontamination at the opening.

11. The sterile access member according to claim 1 wherein the desired temperature and the desired time are sufficient to achieve sterilization at the opening.

12. The sterile access member according to claim 1 wherein the desired temperature is at least 200 C.

13. The sterile access member according to claim 1 wherein the desired temperature is between 230 and 270 C.

14. A connection assembly for connecting a first fluid conduit or container having a first opening into a sterile area within the first container or conduit with a second fluid conduit or container having a penetrating member extending to a sterile area within the second container or conduit, the penetrating member enclosed within a housing defining a second opening, the connection assembly comprising:
a first puncturable foil positioned over and sealing the first or second opening, the first puncturable foil configured such that activation thereof causes at least a portion of the first puncturable foil to automatically heat to a desired temperature for a desired time such that the heated portion of the foil has reached a desired sterile state after which the penetrating member may be extended through the first puncturable foil.

15. The connection assembly according to claim 14 wherein the penetrating member is moveable within the housing.

16. The connection assembly according to claim 14 wherein a second puncturable foil is positioned over and seals the other of the first or second opening, the second puncturable foil configured such that activation thereof causes at least a portion of the second puncturable foil to automatically heat to a desired temperature for a desired time such that the heated portion of the foil has reached a desired sterile state.

17. The connection assembly according to claim 16 wherein each of the puncturable foils is activated through ohmic heating or Joule heating.

18. The connection assembly according to claim 17 wherein each of the puncturable foils has a conductor applied to a surface thereof and defining a current path.

19. The connection assembly according to claim 17 wherein each of the puncturable foils is a polymer film containing metallic powders, ceramic powders, graphite, carbon black and/or other conductive materials within the polymer film.

20. The connection assembly according to claim 16 wherein each of the puncturable foils is activated through induction heating.

21. The connection assembly according to claim 16 wherein each of the puncturable foils is made from an exothermic reactive material.

22. The connection assembly according to claim 21 wherein the exothermic reactive material comprises an arrangement of layers or particles of metals that upon activation undergo an exothermic reaction without any other reagents or products.

23. The connection assembly according to claim 21 wherein each of the puncturable foils is activated through exposure to heat, application of an electric spark, laser, impact, or the application of a sufficient current and/or voltage.

24. The connection assembly according to claim 14 wherein the desired temperature and the desired time are sufficient to achieve disinfection and/or decontamination at the opening.

25. The connection assembly according to claim 14 wherein the desired temperature and the desired time are sufficient to achieve sterilization at the opening.

26. The sterile access member according to claim 14 wherein the desired temperature is at least 200 C.

27. The sterile access member according to claim 14 wherein the desired temperature is between 230 and 270 C.

28. A method for a sterilized connection between first and second fluid conduits and/or containers, the first fluid conduit or container having a first opening into a sterile area within the first container or conduit and the second fluid conduit or container having a penetrating member extending to a sterile area within the second container or conduit, the penetrating member enclosed within a housing defining a second opening, and a first puncturable foil positioned over and sealing the first or second opening, the method comprising:
activating the first puncturable foil wherein at least a portion of the first puncturable foil automatically heats to a desired temperature for a desired times such that the heated portion of the foil has reached a desired sterile state; and
extending the penetrating member through the first puncturable foil.
